(19) United States
(12) Patent Application Publication
(10) Pub. No.: US 2015/0012946 A1
(43) Pub. Date: Jan. 8, 2015

(54) METHODS AND SYSTEMS FOR PRESENTING TAG LINES ASSOCIATED WITH MEDIA ASSETS

(71) Applicant: United Video Properties, Inc., Santa Clara, CA (US)

(72) Inventor: Thomas S. Woods, Arlington Heights, IL (US)

(73) Assignee: United Video Properties, Inc., Santa Clara, CA (US)

(21) Appl. No.: 13/934,639

(22) Filed: Jul. 3, 2013

(51) Int. Cl. H04N 21/84; H04N 21/81; H04N 21/482

(52) U.S. Cl. CPC H04N 21/84; H04N 21/4821; H04N 21/8133
USPC 725/41; 725/40

(57) ABSTRACT

Methods and systems are discussed herein for presenting tag lines associated with media assets in an interactive media guide. For example, a media guidance application may generate a media guide featuring a plurality of media listings. When a user navigates to a media listing, the media guidance application may determine a tag line (e.g., a memorable phrase or scene associated with the media asset that jogs a user's memory) associated with the media listing. The media guidance application may then present the tag line.

### BACKGROUND

Electronic television program guides are widely available. A typical guide includes a grid featuring rows and columns associated with available programs. To take full advantage of such electronic television program guides, users must be able to read and understand the information in the guides. Given space limitations, listings on a grid often are limited to a title (or part of a title), which may not be enough information for a user to recognize/identify the content or evaluate whether or not the user wishes to access the listing.

### SUMMARY

Accordingly, methods and systems are discussed herein for presenting tag lines associated with media assets. Presenting tag lines associated with media assets, for example, in an interactive media guidance application, provides a user with additional information about the media assets. The additional information may help a user identify the content of the media asset as well as determine whether or not he/she wishes to access the media listing. For example, by presenting a famous tag line from the media asset associated with a listing, a user can instantly identify a media asset even if he/she does not recognize the title of the media asset. Moreover, presenting tag lines with media listings offers unique marketing and advertising opportunities (e.g., in order to entice a user to select the media listing).

For example, a media guidance application may generate an interactive media guide featuring a plurality of media listings. When a user navigates to a media listing, the media guidance application may determine a tag line associated with the media listing. The tag line may also include a video, audio, or textual segment of the media asset (e.g., a memorable phrase or scene associated with the media asset that jogs the recollection of the user). The media guidance application may then present (e.g., as an overlay, an audio announcement, or as a separate window) the tag line.

In some aspects, the media guidance application presents tag lines for media objects other than media listings. For example, when a user navigates to a category of media listings, an icon corresponding to a guide function, or a media listing in an interactive guide, a media guidance application may generate a tag line associated with the media object. Based on the tag line the user may determine the content or function of the media object. For example, a category associated with a comedy genre may include a presentation of people laughing and/or a soundtrack recorded of a particular comedy show containing the sound of audience laughter. The sound of laughter may aid the user in identifying the type of content associated with the category as well as motivate the user to select the category.

In some aspects, the media guidance application determines a tag line associated with a media listing by monitoring content of a media asset associated with the media listing during a time period, detecting occurrences of a token scene in the content of the media asset, comparing a number of the occurrences to a threshold number, and in response to the number of the occurrences exceeding the threshold number, determining the token scene is the tag line. For example, the media guidance application may monitor a program for repeated content or other indicia of a tag line (e.g., a large audience reaction). Upon detecting that particular content is repeated a particular number of times (e.g., the number of times necessary for a user to associate the content with the media listing), the media guidance determines that the content is the tag line associated with the media asset.

In some aspects, the media guidance application may select a particular time period to monitor the content of the media asset. For example, the time period may correspond to a contiguous length of time (e.g., a two-hour window) or may correspond to non-contiguous lengths of time (e.g., times when a user is accessing the media asset). The media guidance application may further allow a user to modify the time period or even the tag line that is selected. For example, the media guidance application may allow a user to select custom tag lines for media objects.

Additionally or alternatively, the media guidance application may cross-reference a media object in a local or remote database associated with tag lines of media objects to determine the tag line to associate with the media object, and/or interpret media data transmitted with the interactive guide. Furthermore, in some aspects, the media guidance application may determine current content of a media asset associated with the media listing and modify a tag line based on the current content of the media asset.

For example, the media guidance application may generate a first tag line associated with a media listing when a first type of content is being presented and may generate a second tag line associated with a media listing when a second type of content is being presented.

It should be noted, the systems and/or methods described above may be applied to, or used in accordance with, other systems and/or methods as described below.

### BRIEF DESCRIPTION OF DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows an illustrative example of a media guidance application that may present tag lines associated with media listings in an interactive media guide in accordance with some embodiments of the disclosure;

FIG. 1B shows an illustrative example of a media guidance application presenting a tag line as an overlay in an interactive media guide in accordance with some embodiments of the disclosure;

FIG. 1C shows an illustrative example of a media guidance application presenting a tag line as a separate window in an interactive media guide in accordance with some embodiments of the disclosure;

FIG. 1D shows an illustrative example of a media guidance application presenting a tag line instead of a media listing in an interactive media guide in accordance with some embodiments of the disclosure;

FIG. 2 shows another illustrative example of a media guidance application that may generate tag lines associated with media listings in an interactive media guide in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for presenting tag lines associated with media listings in an interactive media guide in accordance with some embodiments of the disclosure;

FIG. 6 is a flowchart of illustrative steps for determining tag lines in accordance with some embodiments of the disclosure; and

FIG. 7 is a flowchart of illustrative steps for selecting how to determine the tag lines in accordance with some embodiments of the disclosure.

### DETAILED DESCRIPTION OF THE DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

The media guidance application may also generate presentations of tag lines associated with media listings in an interactive media guide. As referred to herein, “tag lines” encompasses any combination of audio, video, and/or textual data that constitutes a memorable phrase or scene associated with a media object such that the content or function of the media object is identified by, or reinforced in the mind of, the user. For example, a tag line may included a famous, or often-quoted, portion of a media asset, a slogan, or variant thereof, used in marketing materials and/or advertisements, a brand indicator or content that otherwise sums up the tone and/or premise of a media asset.

For example, the phrase “May The Force Be With You,” the sight and sound of light sabers clashing, or the robotic breathing of Darth Vader are all popular tag lines associated with the Star Wars franchise. Therefore, in some embodiments, a media guidance application may generate audio/visual presentations incorporating one or more of these tag lines in an interactive media guide featuring a media listing of the Star Wars franchise. For example, when a user navigates to a media listing, the media guidance application may generate a pop-up featuring “May The Force Be With You,” may display a window of Luke Skywalker and Darth Vader engaged in light saber duel, or may generate the sounds of Darth Vader breathing.

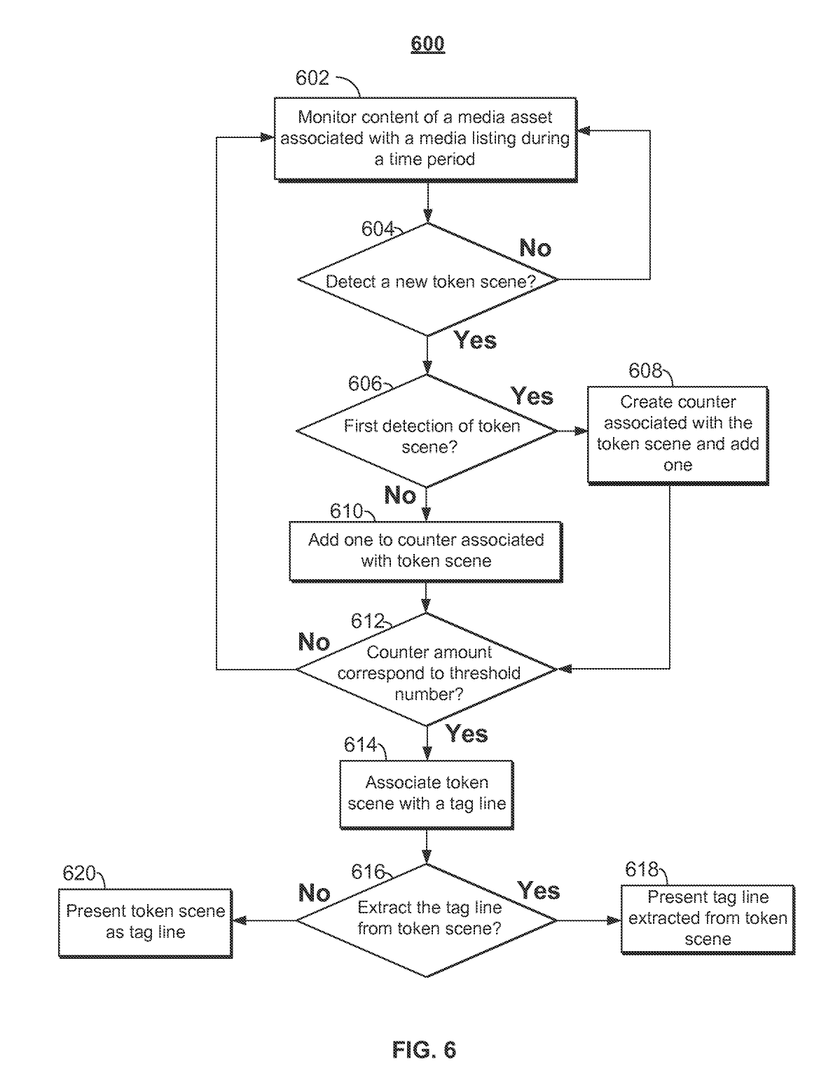

In some embodiments, the tag line may be based on a token scene. As used herein, a “token scene” refers to a distinct segment or portion of a media asset. As described herein, a media asset may be segmented in a variety of ways by the media guidance application. For example, a media asset may be segmented by theatrical scenes (e.g., a series of action and/or dialogue typically in a single location and continuous in time), by increments of time (e.g., five minutes intervals), by particular frames or numbers of frames (e.g., five frames of a video), or by any other occurrences in the media asset. For example, a media asset may be segmented by appearances of a character or object, conversations and/or dialogue performed by the character, individual lines of dialogue of the character, and/or individual words in the lines of dialogue of the character. As described below in relation to FIG. 6, the media guidance application may segment a media asset into a series of token scenes in order to determine a particular tag line associated with a media object.

As used herein, a “media object” refers to human-readable and/or human-recognizable data appearing on the display screen associated with a user device. A media object may be a variable, function, or file. In some embodiments, the media object may appear as a character, icon, and/or input associated with a media asset, media listing, media provider, guide function, advertisement, and/or anything else featured in an interactive media guide. It should be noted that any embodiment disclosed herein referring to one media object or one type of media object (e.g., a media listing) could equally be applied to any other media object or type of media object.

In some embodiments, the media object may correspond to a category or other grouping based on media criteria. As used herein, a “media criterion” or “media criteria” refers to a standard, rule, or test on which a judgment or decision about media assets, media listings, guide functions, media providers, and/or any other property or feature of an interactive media guide can be based. For example, in some embodiments, media criteria may determine the media assets and/or listings, guide functions, etc., corresponding to a particular category identified by a tag line.

A media criterion may relate to any characteristics associated with receiving, viewing, accessing, or navigating media objects, including, but not limited to, broadcast times, broadcast channels, titles, content descriptions, related episodes, series information, ratings information (e.g., parental control ratings, critic's ratings, etc.), genre or category information, cast and crew information, media format (e.g., standard definition, high definition, 3D, etc.), advertisement information (e.g., advertisers or sponsors of a media asset), on-demand information, social media recommendations, user recommendations, price, website referrals, content, delivery type (e.g., broadcast, recorded, streaming, pay-per-view, on-demand), media provider, type of media provider (e.g., Internet, cable, etc.), function type, operation type, and any other information that may describe a media asset, media listing, guide function, media provider, and/or any other property or feature of an interactive media guide.

As referred to herein, the term “media providers” refers to any entity associated with the production, transmission, authorship, or availability to end users of a media asset. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens.

In some embodiments, the user equipment device may have a front facing camera and/or a rear facing camera. On these user equipment devices, users may be able to navigate among and locate the same content available through a television. Consequently, media guidance may be available on these devices as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In addition, media guidance data may also include a tag line that is associated with a media object.

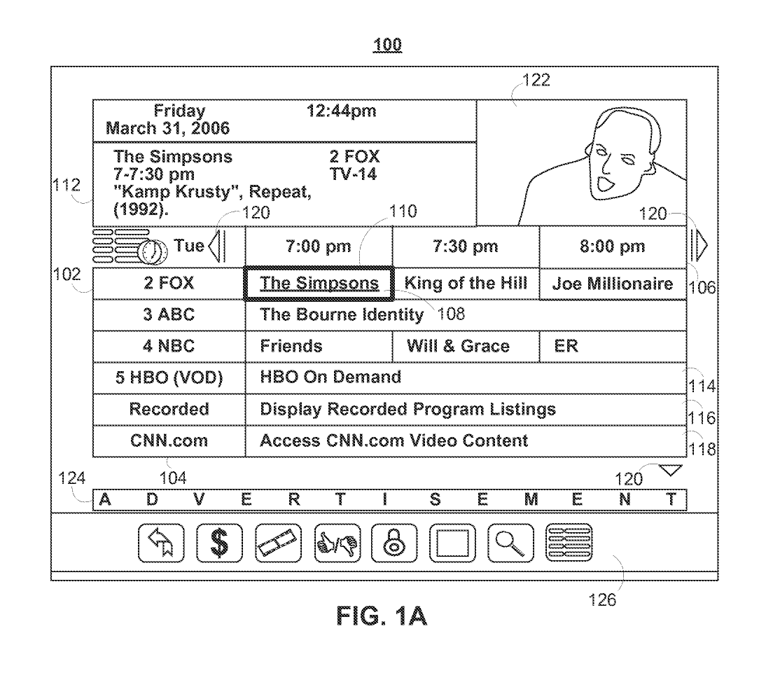

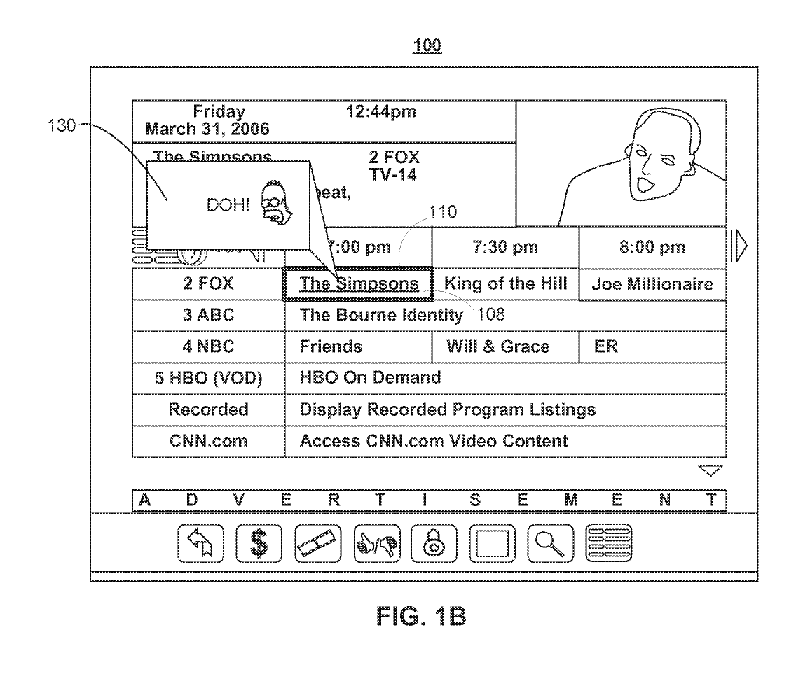

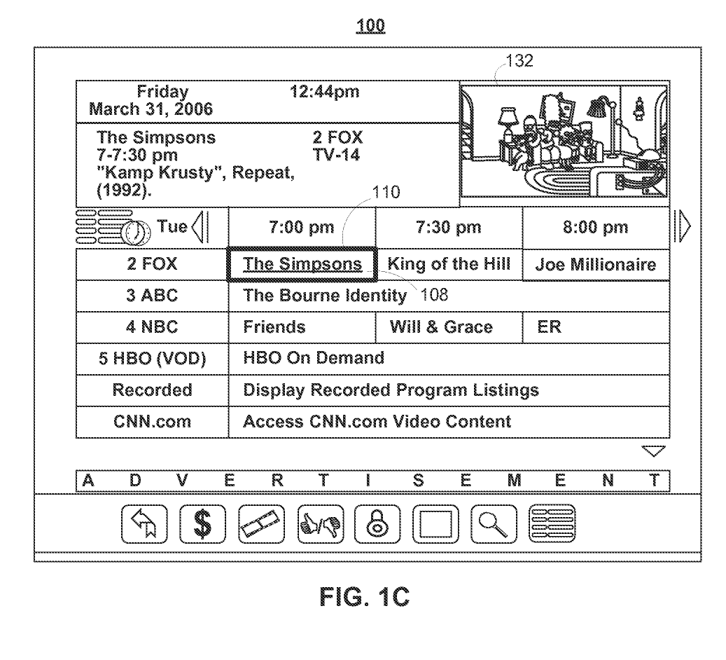

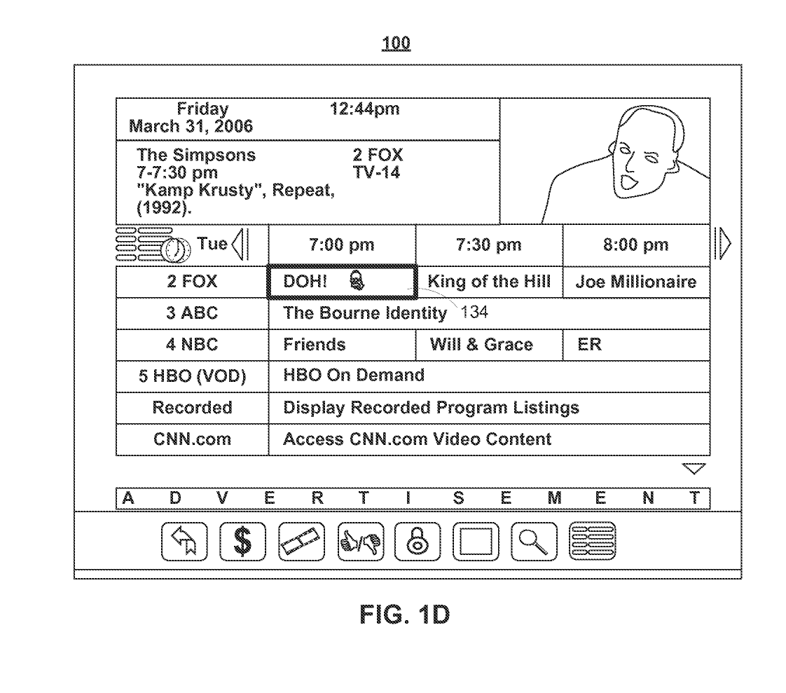

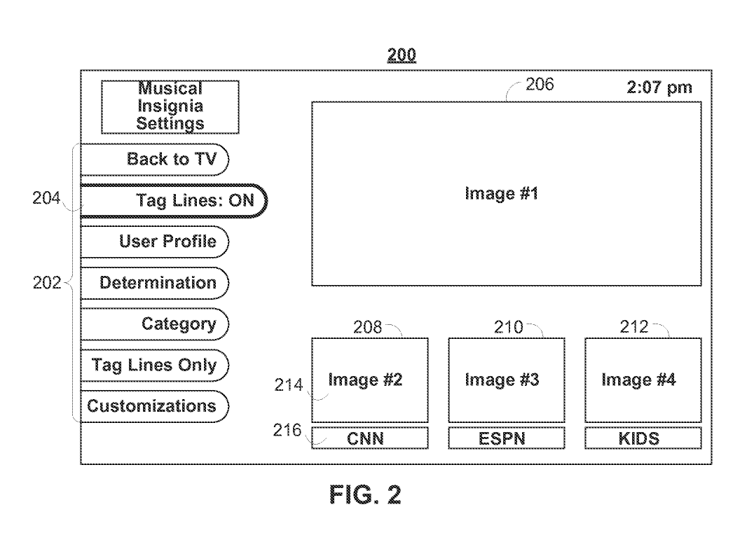

FIGS. 1A-D and FIG. 2 show illustrative display screens that may be used to provide media guidance data, including tag lines associated with media listings. The display screens shown in FIGS. 1A-D and FIG. 2 may be implemented on any suitable user equipment device or platform. While the displays of FIGS. 1A-D and FIG. 2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by media provider (or source), by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information. In some embodiments, the media guidance data may be filtered by the media guidance application according to whether or not the media guidance data is associated with a tag line.

FIG. 1A shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. As the user moves highlight region 110, the media guidance application may generate a presentation of a tag line of a media object within highlight region 110.

Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. Upon selecting the media guidance data associated with any of these listings, the media guidance application may also determine a tag line for each and generate a presentation of the determined tag line.

A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Upon selecting the media guidance data associated with any of these regions, the media guidance application may also determine a tag line for each and generate a presentation of the determined tag line. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Upon selecting the media guidance data associated with any of these options, the media guidance application may also determine a tag line for each and generate a presentation of the determined tag line. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

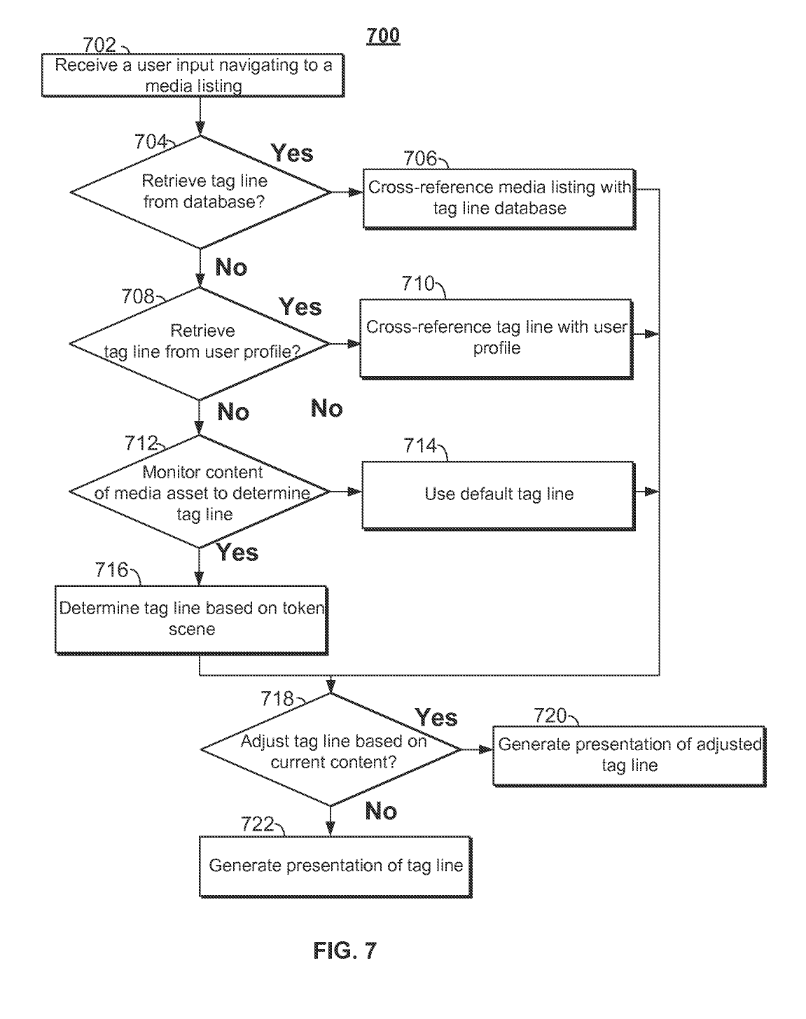

The media guidance application, including any tag lines associated with media objects, may be personalized based on a user's preferences. A personalized media guidance application allows a user to customize displays, tag lines and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the media guidance application. Customization of the media guidance application may be made in accordance with a user profile. The customizations may include selecting how tag lines should be determined (e.g., as discussed below in relation to FIG. 7), manually adjusting determined tag lines, applying settings that automatically modify tag lines, varying presentation schemes (e.g., color scheme of displays, font size of text, volume of presentations, pitch of presentation, etc.), aspects of content listings displayed (e.g., only media objects with accompanying tag lines, only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application (e.g., in order to determine tag lines to associate with a media listing). Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 1B shows an illustrative example of a media guidance application presenting a tag line as an overlay in an interactive media guide. For example, in FIG. 1B, the media guidance application has generated a presentation of tag line 130. In response to a user selecting (e.g., with highlight region 110) a media listing (e.g., program listing 108), the media guidance application may generate a pop-up featuring tag line 130 associated with the selected media listing.

For example, “The Simpsons” is currently selected. In response, the media guidance application presents the text “DOH!,” which corresponds to a frequently used phrase of one of the characters of the program. In addition, tag line 130 includes an image displaying the character of the program related to the tag line. In some embodiments, tag line 130 may additionally or alternatively include audio or video presentations.

For example, instead of a textual description, the media guidance application may generate a short clip or video segment associated with the tag line. For example, the media guidance application may generate for display an actual clip from the program in which the character uses the tag line. The media guidance application may also generate an audio announcement associated with tag line 130 (e.g., a vocal expression of “DOH!”).

Tag line 130 is currently displayed as an overlay or pop-up; however, tag line 130 could also be generated for display in any other appropriate manner. For example, in FIG. 1C tag line 132 is generated for display in a separate window. For example, in response to a user selecting (e.g., with highlight region 110) a media listing (e.g., program listing 108), the media guidance application generates for display a popular scene from the program as tag line 132. Tag line 132 is featured in a separate window, which formally was associated with video region 122 (FIG. 1A). Additionally or alternatively, tag line 132 may appear as a PIP window overlaid on display 100.

In some embodiments, the media guidance application may associate a particular media listing (e.g., program listing 108) with a single tag line (e.g., tag line 130 (FIG. 1B)) or multiple tag lines (e.g., tag line 130 (FIG. 1B) and tag line 132 (FIG. 1C)). The media guidance application may rank or sort the various tag lines by numerous means.

For example, the media guidance application may determine, which tag line is most relevant to the current content of the media asset associated with the media listing. For example, if the media asset is part of serial program, individual seasons or episodes (e.g., corresponding to a story arc) may have particularly relevant tag lines. The media guidance application may determine which tag line is the most relative to the current content and display the appropriate one based on the methods described in FIG. 7 below.

The media guidance application may also determine a ranking for individual tag lines associated with the same media listing. For example, the media guidance application may monitor other sources (e.g., social media, news sites, etc.) for uses of a particular tag line in popular culture or by the user. As a particular tag line becomes more popular, the media guidance application may determine to display that tag line more often (or in preference to other tag lines). The media guidance application may also monitor the other sources for uses that are not associated with the media asset. For example, if a tag line that was previously associated with a television program is used frequently in other contexts or has lost its distinctiveness such that a user no longer is likely to associate it with the media asset, the media guidance application may lower its ranking or remove it completely from the available tag lines that may be presented with the media listing. For example, the media guidance application may determine that if a tag line no longer serves its purpose (e.g., identifying and/or marketing a media listing to a user), the media guidance application may no longer associate that tag line with the media listing.

The media guidance application may also modify the tag line based on the user and/or user preferences. For example, the media guidance application may have several formats (e.g., audio, video, textual, etc.) of the tag line, and the user may select which version he/she prefers to have presented. Additionally or alternatively, the media guidance application may monitor the user interactions of the user with the media guidance application to select a particular tag line. For example, if a user selects a media listing more often when a first tag line is presented than when a second tag line is presented, the media guidance application may rank the first tag line higher than the second.

In some embodiments, the tag line may become distinctive enough or so closely related to the media asset, that the tag line is displayed instead of the title or other information in the media listing. For example, FIG. 1D shows an illustrative example of a media guidance application presenting a tag line instead of a media listing in an interactive media guide.

In FIG. 1D, tag line 134 has replaced other information in the media listing (e.g., the title of the media asset). For example, in response to a user selecting (e.g., with highlight region 110 (FIG. 1A)) a media listing (e.g., program listing 108 (FIG. 1A)), the media guidance application has altered the media listing to display only tag line 134. Tag line 134 may scroll/crawl from one side of the media listing to the other, may generate sound, and/or may flash and return to the previously displayed information associated with the media listing. If the tag line features a scene from an associated media asset, the media guidance application may present the scene in the area corresponding to the media listing. Alternatively, the media guidance application may present tag lines (e.g., tag line 134) instead of other information associated with media listings. For example, in some embodiments, the media guidance application may generate an interactive program guide featuring tag lines instead of other information of the media listing. For example, the interactive media guidance may display tag lines for available programs instead of the titles for available programs.

Another display arrangement for providing media guidance is shown in FIG. 2. Video mosaic display 200 includes a set-up screen associated with generating presentations of tag lines. Selectable options 202 provide options for modifying tag lines associated with various media objects. For example, selection of “user profile” settings may allow a user to edit any tag lines associated with any media object, any other information stored in his/her user profile, or switch between various user profiles. Selection of a “determination” method setting may allow a user to select the type of method for determining a particular tag line (e.g., as discussed below in relation to FIG. 7). Selection of “category” setting may allow a user to customize categories and/or tag lines associated with categories. Selection of a “tag lines only” setting may allow a user to filter all available media listings, guide functions, available categories, etc. based on whether or not a tag line is presented, and selection of a “customization” setting may allow a user to customize any features provided by media guidance application and/or any tag line for any media object.

In display 200, selectable option 204 is selected, thus initiating presentations of tag lines. In addition, the media guidance application provides listings 206, 208, 210, and 212 as broadcast program listings. In display 200 the listings may provide graphical images including cover art, still images from the content, video clip previews, live video from the content, or other types of content (e.g., audio notifications of tag lines) that indicate to a user the content being described by the media guidance data in the listing.

Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

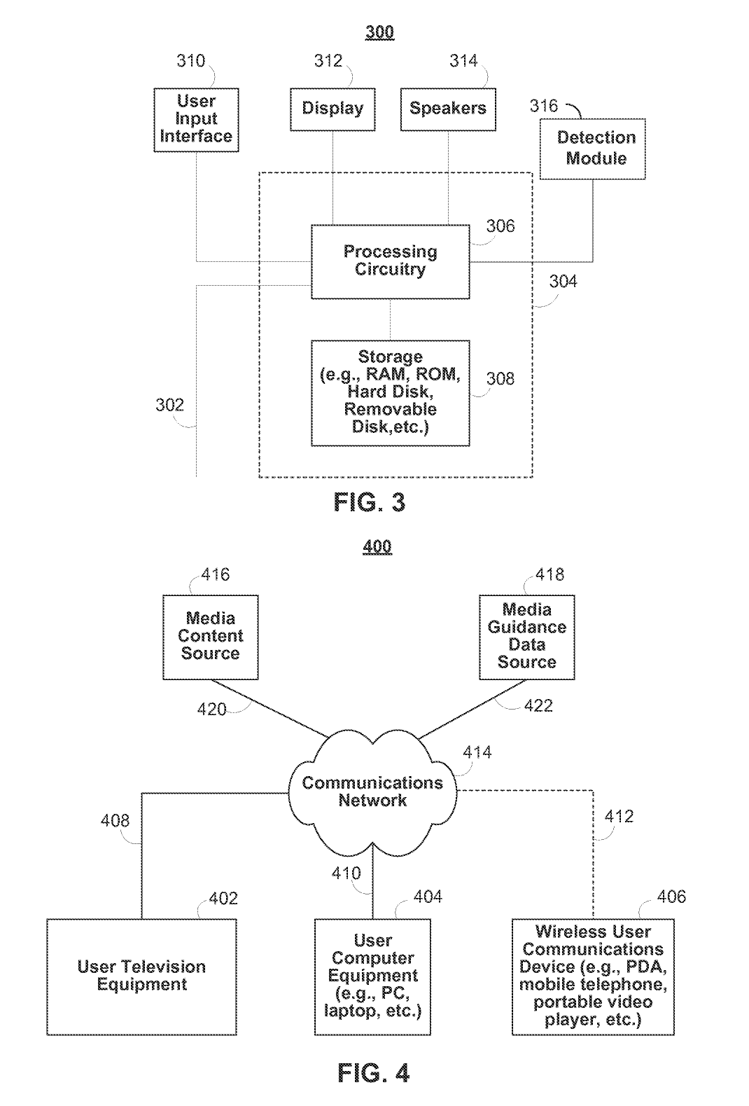

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above and/or, tag lines associated with media objects as well as attributes of tag lines. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

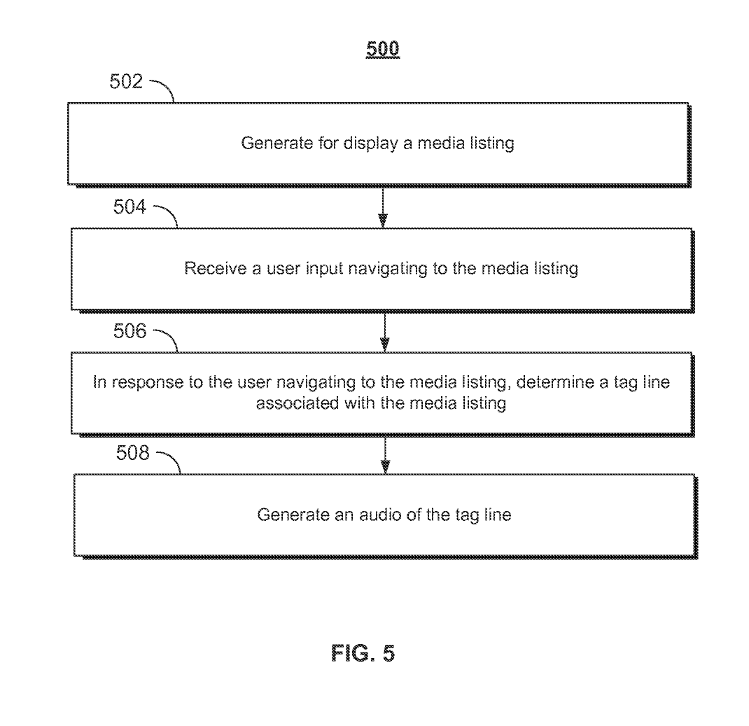

FIG. 5 is a flowchart of illustrative steps for generating tag lines for media listings in an interactive media guide. Process 500 may be used to generate the display screens and tag lines shown and described in FIGS. 1A-D and FIG. 2. It should be noted that process 500 or any step thereof could be provided by any of the devices shown in FIGS. 3-4. For example, process 500 may be executed by control circuitry 304 (FIG. 3) as instructed by a media guidance application implemented on user equipment device 402, 404, and/or 406 (FIG. 4) to generate tag lines as a user navigates an interactive program guide (e.g., display 100 (FIG. 1)) displayed on a display device (e.g., display 312 (FIG. 3)) accessible by the media guidance application.

At step 502, the media guidance application generates an interactive guide display that includes a media listing. For example, the media guidance application may generate a listing (e.g., program listing 108 (FIG. 1A)) of a currently available media asset. In some embodiments, the media listing may meet particular media criteria. For example, the media listing may appear as part of a search or category function provided by the media guidance application.

In some embodiments, the media listing may appear after one or more filtering operations are applied to all available media listings. For example, the media guidance application may filter the available media listings according to whether or not the media listing is associated with a media asset of a particular genre. Additionally or alternatively, the media guidance application may filter the available media listings according to whether or not the media listing is associated with a tag line and/or whether the media guidance application will present a presentation of a tag line in response to a user selection. For example, in some embodiments, a user may wish to view only media listings that are associated with a tag line. In such cases, the user may select access the filtering feature via on-screen options (e.g., selectable options 202 (FIG. 2)).

At step 504, the media guidance application receives a user input navigating to the media listing. For example, using user input interface 310 (FIG. 3)), a user may navigate about an interactive guide (e.g., as shown and described in relation to FIGS. 1A-D and FIG. 2). In some embodiments, the media guidance application may respond to vocal and/or gesture-based commands. In some embodiments, as commands are received by the media guidance application, the media guidance application may generate (e.g., via control circuitry 304 (FIG. 3)) an audio/video response such that a user receives confirmation that an input was received.

At step 506, the media guidance application determines a first tag line associated with the media listing. In some embodiments, the tag line is unique to the media listing. For example, the tag line may not be associated with any other media listing and/or media object. If the media guidance application determines that two media objects (e.g., two media listings) are associated with the same tag line, the media guidance application may resolve the conflict by assigning the tag line to one of the media objects and generating a custom tag line of the other. For example, the media guidance application may determine to assign one of the media objects the tag line based on that media object having superior characteristics (e.g., higher ratings, more previous user interactions, user preferences, etc.) than the other media object. Additionally or alternatively, the media guidance application may slightly modify the tag line for one or more media objects. For example, the tag line may be played at a higher (or lower) pitch, faster (or slower) beat, displayed in a different font, include images and/or additional content associated with the media asset, and/or any other distinguishing features so that the tag line for each media object is unique.

The media guidance application may determine a tag line to associate with the media listings through a variety of means. In some embodiments, the media guidance application may determine a tag line to associate with a media listing and/or media object based on media guidance data (e.g., received from media guidance data source 418 (FIG. 4)). In some embodiments, information relating to a tag line may be received with content (e.g., as metadata) from media content source 416 (FIG. 4)). In some embodiments, the tag line may determine the tag line based on monitoring media associated with media objects (e.g., as discussed below in relation to FIG. 6)).

In some embodiments, the media guidance application may determine a tag line to associate with a media listing and/or object based on cross-referencing a database associated with tag lines. For example, as discussed below in relation to FIG. 7, the media guidance application may query a database located either locally (e.g., in storage 308 (FIG. 3)) or remotely (e.g., media content source 416 (FIG. 4), media guidance data source 418 (FIG. 4), and/or any location accessible via communications network 414 (FIG. 4)) to user device (e.g., user device 300 (FIG. 3)) upon which the media guidance application is implemented.

In some embodiments, the database may be structured as a look-up table. For example, the media guidance application may query (e.g., using control circuitry 304 (FIG. 3)) the database for a tag line associated with a particular media listing (e.g., program listing 108 (FIG. 1A)). For example, the media guidance application may input a unique identifier (e.g., the name of the media asset, a serial number associated with particular media objects, etc.) into the database. In response, the media guidance application may receive (e.g., via I/O path 302 (FIG. 3)) the output of the database may output a tag line associated with the unique identifier.

Additionally or alternatively, the media guidance application may input media criteria into the database (e.g., describing the media object) and then filter the available tag lines based on the media objects that correspond to the media criteria. For example, in order to determine a tag line for a media listing, the media guidance application may input the title, media provider, etc. into the database in order to filter out any tag line not associated with media listings corresponding to the same title, media provider, etc. In some embodiments, the media guidance application may perform multiple iterations of filtering in order to obtain only a single media object associated with a single tag line.

For example, if a media object is a media listing for a media asset, the media guidance application may generate a tag line based on a phrase or opening credits found in the media asset. In such cases, the media guidance application may input the title, media provider, etc. of the media listing or media asset into the database and receive information about the opening credits of the media asset. In some embodiments (e.g., as discussed below in FIG. 7), the media guidance application may extract a tag line from the opening credits or designate the opening credits (or a portion thereof) as the tag line.

In addition, the media guidance application may use multiple types of optical character recognition and/or fuzzy logic, for example, when analyzing media guidance data, the content of media assets, or comparing multiple data fields (e.g., as contained in the described databases). For example, the media guidance application may arrange the text into data fields and cross-reference the data fields with other data fields. Using fuzzy logic, the system may determine two fields and/or values to be identical, even though the substance of the data field or value (e.g., two different spellings) is not identical. In some embodiments, the system may analyze particular data fields of a database for particular values or text. Furthermore, the data fields may contain values (e.g., the data fields could be expressed in binary or any other suitable code or programming language) other than human-readable text.

At step 508, the media guidance application may generate a presentation of the tag line. For example, the media guidance application may transmit a command (e.g., via control circuitry 304 (FIG. 3)) to generate a presentation (e.g., via display 312 and speakers 314 (FIG. 3)) of the tag line with the user device (e.g., user device 300 (FIG. 3)) upon which the media guidance application is implemented.

In some embodiments, the media guidance application may also generate presentations of tag lines on other devices. For example, while a user is navigating through an interactive guide on a first device (e.g., a television), the media guidance application may instruct (e.g., via control circuitry 304 (FIG. 3)) a second device (e.g., a mobile phone, a hearing aid, etc.) to generate the presentation of the tag line. For example, if a user is currently sitting at a distance from a display device (e.g., a television) that makes reading information on an interactive media guide difficult, the media guidance application may (e.g., either in response to a user request or automatically upon determining the distance of the user from the display device) instruct another device (e.g., associated with a user profile of a user) to generate the presentations. In another example, a user may designate another device (e.g., other than the device receiving user inputs), in which to generate presentations of tag lines.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, or in parallel, or substantially simultaneously, to reduce lag or increase the speed of the system or method.

FIG. 6 is a flowchart of illustrative steps for determining tag lines. Process 600 may be used to generate the display screens and tag lines shown and described in FIGS. 1A-D and FIG. 2. It should be noted that process 600 or any step thereof could be provided by any of the devices shown in FIGS. 3-4. For example, process 600 may be executed by control circuitry 304 (FIG. 3) as instructed by a media guidance application implemented on user equipment device 402, 404, and/or 406 (FIG. 4) to tag lines as a user navigates an interactive program guide (e.g., display 100 (FIG. 1)) displayed on a display device (e.g., display 312 (FIG. 3)) accessible by the media guidance application.

As discussed above, the media guidance application may determine the tag line to associate with a media listing using several methods, or a combination thereof. For example, the media guidance application may determine a tag line based on media guidance data, based on user inputs or information in a user profile, and/or based on cross-referencing a database associated with tag lines. Additionally or alternatively, the media guidance application may determine a tag line to associate with a media listing based on monitoring content or functions associated with the media listing.

Process 600 is another method for determining a tag line to associate with a media listing. In FIG. 6, a media guidance application determines a tag line associated with a media listing based on the content of media assets that is frequently accessed by a user or presented by the media asset. It should be noted that in some embodiments, process 600 may be used in combination with other methods of determining a tag line. Moreover, in some embodiments, process 600 may be combined with process 500 (FIG. 5) or process 700 (FIG. 7) and/or modified based on a user profile or a user input (e.g., selecting one of selectable options 202 (FIG. 2)).

At step 602, the media guidance application monitors content of a media asset associated with a media listing during a period of time. For example, the media guidance application may determine the content of a media asset by analyzing the content of available media assets. In some embodiments, the media guidance application may incorporate or have access to one or more content-recognition modules, which may be used by the media guidance application to analyze media objects and/or the content of media objects. For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio content. For example, the media guidance application may receive a media asset in the form of a video (e.g., an audio/video recording of a user). The video may include a series of frames. For each frame of the video, the media guidance application may use an object recognition module to determine the content and context of a media asset for use in determining a tag line to associate with the media listing.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text or other data forms that may be processed by the media guidance application. The content-recognition module may also use any other suitable techniques for processing audio and/or visual data. For example, the content-recognition module may analyze audio data to determine the content and context of a media asset for use in determining a tag line to associate with the media listing.

The amount of time that the media guidance application monitors content of a media asset associated with a media listing may vary. For example, in some embodiments, the media guidance application may monitor the content of the media asset continuously. The media guidance application may also monitor all media assets (e.g., different episodes, seasons, movies, version, etc.) associated with a media listing (e.g., including different media assets linked to the media asset by similar media criteria (e.g., a shared franchise)). Alternatively, the media guidance application may monitor the content of the media asset, or select the media assets that are monitored sporadically. The time period may also be linked to other factors such as user preferences, ratings, social media activity, etc. The amount of time that the content is monitored may also depend on other factors such as user preferences, times when the user is accessing media asset, etc.

At step 604, the media guidance application determines whether or not a new token scene is detected. For example, the media guidance application may segment the media asset into token scenes and monitor the content of each token scene individually. In addition, token scenes may be distinguished by the media guidance application based on monitoring the media asset. For example, if each token scene constitutes five seconds of the run-time of the media asset or five frames of the media asset, the media guidance application may access a clock or frame-counting component to track/distinguish the segments. Additionally or alternatively, if each token scene is determined based on other factors (e.g., tags embedded in the media asset), the media guidance application may monitor for the occurrence of the tags.

If a token scene is not detected, the media guidance application returns to step 602 and continues to monitor the content of the media associated with the media asset. If the media guidance application does detect a token scene, the media guidance application determines whether or not this is the first instance that this particular token scene was detected at step 606.

If this is the first instance of the particular token scene, the media guidance application creates a counter associated with the detected token scene and adds one unit to the counter at step 608. If this is not the first instance of the particular token scene, the media guidance application adds one unit to the counter associated with the particular token scene at step 610. For example, the media guidance application may (e.g., via control circuitry 304 (FIG. 3)) maintain a count of each token scene (e.g., in storage 308 (FIG. 3) of user equipment 402, 404, and/or 406 (FIG. 4)). Each time a token scene is detected, the media guidance application (e.g., via control circuitry 304 (FIG. 3)) may compare the detected token scene to the stored token scenes (e.g., in storage 308 (FIG. 3)).

At step 612, the media guidance application determines whether or not the counter amount for the token scene corresponds to a threshold number. For example, a threshold number may be a number of instances of a token scene after which a user will associate the token scene with the media asset. For example, if a particular catch-phrase is stated during a media asset enough times, a user will start to associate the tones with the media asset. In some embodiments, the instances of the token scene may all occur during a particular media asset (e.g., an episode of a program) or in different media assets (e.g., different series or movies of a single franchise). For example, the token scene may be associated with a theme song or scene that is featured in a program (e.g., in the opening credits or frequently during the duration of the program).

In some embodiments, the threshold number may be determined based on a user profile (e.g., according to a user preference). The media guidance application may also determine a threshold number based on passive information, such as observing user interactions, industry metrics, etc., or active information, such as requesting the user answer questionnaires. The threshold number may be retrieved from a remote database (e.g., located at media content source 416, media guidance data source 418, and/or any device accessible via communications network 414 (FIG. 4)) or a local database (e.g., located at storage 308 (FIG. 3)).

If the number of token scenes recorded by the counter corresponds to the threshold number (e.g., is equal to the threshold number), the media guidance application determines the token scene to be the tag line associated with the media listing at step 614, and proceeds to step 616. If the number of token scenes recorded by the counter does not correspond to the threshold number (e.g., is less than the threshold number), the media guidance application returns to step 602.

At step 616, the media guidance application determines whether to extract the tag line from the token scene. For example, the media guidance application may determine not to extract a tag line and instead designate that the entire token scene (e.g., the token scene associated with the tag line in step 614) constitutes the tag line. If so, the media guidance application proceeds to step 620, and presents the token scene as the tag line. For example, the tag line presented to a user may include a clip or video segment of the actual media asset (e.g., as described in relation to tag line 132 (FIG. 1C)).

Alternatively, at step 616, the media guidance application may determine to extract the tag line from the token scene. For example, the media guidance application may determine to extract only an audio segment from the token scene. In another example, the media guidance application may extract only sub-titles from the token scene (e.g., in order to generate a textual tag line). If so, the media guidance application proceeds to step 618, and presents the tag line extracted from the token scene. For example, the tag line presented to a user may include only text or audio (e.g., extracted from a multimedia token segment).

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, or in parallel, or substantially simultaneously, to reduce lag or increase the speed of the system or method.

FIG. 7 is a flowchart of illustrative steps for selecting how to determine the tag lines. Process 700 may be used to generate the display screens and tag lines shown and described in FIGS. 1A-D and FIG. 2. It should be noted that process 700, or any step thereof, could be provided by any of the devices shown in FIGS. 3-4. For example, process 700 may be executed by control circuitry 304 (FIG. 3) as instructed by a media guidance application implemented on user equipment device 402, 404, and/or 406 (FIG. 4) to tag lines as a user navigates an interactive program guide (e.g., display 100 (FIG. 1A)) displayed on a display device (e.g., display 312 (FIG. 3)) accessible by the media guidance application.

FIG. 7 relates to various ways to determine a tag line associated with a media listing. It should be noted that any of the ways disclosed above and below can be performed before, during, or after a media listing is selected by a user or displayed (e.g., on display 100 (FIG. 1A)) in a interactive guide generated by the media guidance application. For example, the media guidance application may determine (e.g., via control circuitry 304 (FIG. 3)) a tag line to associate with a media listing prior to a user selecting, or the media guidance application presenting and storing the tag line on a remote database (e.g., located at media content source 416, media guidance data source 418, and/or any device accessible via communications network 414 (FIG. 4)) or a local database (e.g., located at storage 308 (FIG. 3)). The tag line may then be retrieved by the media guidance application when required (e.g., when a user navigates to the associated media listings (e.g., as described in relation to FIG. 1B)).

Alternatively or additionally, as described in FIG. 7, the media guidance application may determine the tag line associated with a media listing in real-time when a user selects a media listing. In some embodiments, a tag line (e.g., tag line 130 (FIG. 1B)) may be transmitted in media guidance data (e.g., received from media guidance data source 418 (FIG. 4)). The media guidance application may then retrieve the tag line from the media guidance data as necessary.

At step 702, the media guidance application receives a user input navigating to a media listing. For example, the media guidance application may receive a user input (e.g., via user input interface 310 (FIG. 3)) selecting (e.g., with highlight region 110 (FIG. 1)) a media listing (e.g., program listing 108 (FIG. 1)).

At step 704, the media guidance application determines whether or not to retrieve a tag line from a tag line database. In some embodiments, the tag line database may be located remotely (e.g., at media content source 416, media guidance data source 418, and/or any location accessible via communications network 414 (FIG. 4)) or locally (e.g., on user equipment 402, 404, and/or 406 (FIG. 4)).

The tag line database may include tag lines determined by third parties or media providers. For example, in some embodiments, the media guidance application may receive the tag line associated with a media listing for a program from the third party entity that created or produced the media asset associated with the media listing. If the media guidance application determines to retrieve the tag line from a tag line database, the media guidance application proceeds to step 706 and cross-references the media listing with a tag line database.

For example, the database may be structured as a look-up table that the media guidance application may query (e.g., using control circuitry 304 (FIG. 3)) for a tag line associated with a particular media listing (e.g., a television program). In some embodiments, the media guidance application may input (e.g., via control circuitry 304 (FIG. 3)) a unique identifier (e.g., the name of the media asset, a serial number associated with particular media asset, etc.) into the database, and in response, the media guidance application may receive (e.g., via I/O path 302 (FIG. 3)) a tag line associated with the unique identifier.

If the media guidance application determines not to retrieve the tag line from a tag line database, the media guidance application proceeds to step 708. At step 708, the media guidance application determines whether or not to retrieve a tag line from a user profile. In some embodiments, the user profile may be located remotely (e.g., at media content source 416, media guidance data source 418, and/or any location accessible via communications network 414 (FIG. 4)) or locally (e.g., on user equipment 402, 404, and/or 406 (FIG. 4)).

The user profile may include tag lines determined by the user. For example, in some embodiments, the media guidance application may receive the tag line based on prior user selections or tag lines based on user preferences indicated in the user profile. If the media guidance application determines to retrieve the tag line from a user profile, the media guidance application proceeds to step 710 and cross-references the media listing with the user profile.

For example, the user profile may be structured as a look-up table that the media guidance application may query (e.g., using control circuitry 304 (FIG. 3)) for a tag line associated with a particular media listing (e.g., a television station) or conditions or rules associated with selecting a tag line. In some embodiments, the media guidance application may input (e.g., via control circuitry 304 (FIG. 3)) a unique identifier or rules into the user profile, and in response, the media guidance application may receive (e.g., via I/O path 302 (FIG. 3)) a tag line associated with the unique identifier.

The user profile may include a designation of a tag line, or may include instructions for customizing or otherwise modifying the tag line. Accordingly, the unique identifier may, in some embodiments, direct the media guidance application to the designated tag line and/or the instructions for customizing or otherwise modifying the tag line

If the media guidance application determines not to retrieve the tag line from a tag line database, the media guidance application proceeds to step 712. At step 712, the media guidance application determines whether to monitor content of a media asset associated with the media listing to determine tag line (e.g., as discussed above in relation to FIG. 6). For example, if a media listing is associated with a particular media asset (e.g., a highly rated program), the media guidance application may select a tag line typically associated with the program. If the media guidance application determines to monitor content associated with a media asset associated with the media listing to determine a tag line, the media guidance application proceeds to step 716.

If the media guidance application determines not to monitor content associated with a media object to determine a tag line (e.g., as discussed above in relation to FIG. 6), the media guidance application uses a default tag line at step 714. For example, the media guidance application may select a tag line at random or may provide a verbal description of the media listing (e.g., generating a presentation of any text displayed on the interactive guide).

Following step 714 or step 716, the media guidance application proceeds to step 718. At step 718, the media guidance application may adjust the tag line based on current content or any other factor. For example, the media guidance application may adjust a determined tag line in order to make it correspond to the current content of a media asset associated with the media listing. For example, if a media asset is currently providing an action movie, the tag line may be played at a higher volume. In another example, if the media asset is associated with multiple tag lines, for example, as determined by one or more of the steps above, the media guidance application may select one of the tag lines to present to a user.

If the media guidance application determines to adjust the tag line based on the current content, the media guidance application proceeds to step 720 and generates a presentation of the adjusted tag line. If the media guidance application determines not to adjust the tag line based on the current content, the media guidance application proceeds to step 722 and generates a presentation of determined tag line without any adjustment.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method of presenting tag lines associated with media assets, the method comprising:
generating for display a media listing;
receiving a user input navigating to the media listing;
in response to the user navigating to the media listing, determining a first tag line associated with the media listing; and
generating a presentation of the first tag line.

2. The method of claim 1, further comprising replacing the media listing with the presentation of the first tag line.

3. The method of claim 1, further comprising:
generating a media object, wherein the media object includes a category of media listings, an icon associated with a guide function, or a media provider;
receiving a user input navigating to the media object;
in response to the user navigating to the media object, determining a second tag line associated with the media object, wherein the second tag line is unique to the media object; and
generating a presentation of the second tag line.

4. The method of claim 1, wherein determining the first tag line associated with the media listing further comprises:
monitoring content of a media asset associated with the media listing during a time period;
detecting occurrences of a token scene in the content of the media asset;
comparing a number of the occurrences to a threshold number; and
in response to the number of the occurrences exceeding the threshold number, associating the token scene with first tag line.

5. The method of claim 4, wherein the time period is associated with a period of time in which a user accesses the media listing.

6. The method of claim 1, further comprising generating for display the first tag line in an overlay related to the media listing.

7. The method of claim 1, further comprising determining the first tag line based on cross-referencing the media listing in a database associated with tag lines of media listings.

8. The method of claim 1, further comprising determining the first tag line based on interpreting media data used to generate the interactive media guide.

9. The method of claim 1, wherein generating the presentation of the first tag line includes generating video, audio, or textual data associated with the first tag line.

10. The method of claim 1, further comprising receiving a user input modifying the first tag line.

11. A system of presenting tag lines associated with media assets, the system comprising control circuitry configured to:
generate for display a media listing;
receive a user input navigating to the media listing;
in response to the user navigating to the media listing, determine a first tag line associated with the media listing; and
generate a presentation of the first tag line.

12. The system of claim 11, further comprising control circuitry configured to replace the media listing with the presentation of the first tag line.

13. The system of claim 11, further comprising control circuitry configured to:
generate a media object, wherein the media object includes a category of media listings, an icon associated with a guide function, or a media provider;
receive a user input navigating to the media object;
in response to the user navigating to the media object, determine a second tag line associated with the media object, wherein the second tag line is unique to the media object; and
generate a presentation of the second tag line.

14. The system of claim 11, wherein the control circuitry configured to determine the first tag line associated with the media listing is further configured to:
monitor content of a media asset associated with the media listing during a time period;
detect occurrences of a token scene in the content of the media asset;
compare a number of the occurrences to a threshold number; and
in response to the number of the occurrences exceeding the threshold number, associate the token scene with first tag line.

15. The system of claim 14, wherein the time period is associated with a period of time in which a user accesses the media listing.

16. The system of claim 11, further comprising control circuitry configured to generate for display the first tag line in an overlay related to the media listing.

17. The system of claim 11, further comprising control circuitry configured to determine the first tag line based on cross-referencing the media listing in a database associated with tag lines of media listings.

18. The system of claim 11, further comprising control circuitry configured to determine the first tag line based on interpreting media data used to generate the interactive media guide.

19. The system of claim 11, wherein the control circuitry configured to generate the presentation of the first tag line is further configured to generate video, audio, or textual data associated with the first tag line.

20. The system of claim 11, further comprising control circuitry configured to receive a user input modifying the first tag line.

21-40. (canceled)
